(19) United States
(12) Patent Application Publication
(10) Pub. No.: US 2003/0135797 A1
(43) Pub. Date: Jul. 17, 2003

(54) Method and apparatus for enhancing the transmission of error in the IEEE 802.11e systems

(76) Inventor: Sunghyun Choi, Seoul (KR)

Correspondence Address: PHILIPS ELECTRONICS NORTH AMERICAN CORP, 580 WHITE PLAINS RD, TARRYTOWN, NY, 10591, US

(21) Appl. No.: 10/247,200

(22) Filed: Sep. 19, 2002

Related U.S. Application Data
(60) Provisional application No. 60/348,703, filed on Jan. 15, 2002.

(51) Int. Cl. G06F 11/00

(52) U.S. Cl. 714/704; 714/748

(57) ABSTRACT

The present invention relates to a method and system for enhancing the performance of the Forward-Error-Correction (FEC) scheme in a wireless local area network (WLAN). When a transmission error occurs more than a predetermined number of times using a first modulation scheme, the data transmission rate of the first modulation scheme is compared to a predetermined data rate and, if greater, the retransmission of error data is performed using a second modulation scheme.

### BACKGROUND OF THE INVENTION

1. Field of the Invention

The invention pertains to wireless local area networks (WLANs) and particularly to enhance the performance of the Forward-Error-Correction (FEC) scheme defined in the upcoming IEEE 802.11e Medium-Access-Control (MAC) protocol.

2. Description of the Invention

The IEEE 802.11 WLAN standard provides a number of physical-layer options in terms of data rates, modulation types, and spreading-spectrum technologies. An extension of the IEEE 802.11 standard, namely IEEE 802.11a, defines a physical layer based on the orthogonal-frequency-division multiplexing (OFDM) and requirements operating in the 5 GHz U-NII frequency and eight PHY modes With different modulation and data rates ranging from 6 Mps to 54 Mps. Forward-error correction is performed by bit interleaving and rate ½-convolutional coding.

Recently, the IEEE 802.11e standard has been proposed to enhance the current 802.11 MAC by expanding support for LAN applications with Quality of Service requirements. Examples of applications include transport of voice, audio, and video over 802.11 wireless networks; video conferencing; media-stream distribution; enhanced security applications; and mobile and nomadic access applications. The IEEE 802.11e Medium Access Control (MAC) optionally defines MAC-level Forward Error Correction (FEC), based on a well-known Reed-Solomon (RS) code, for a more reliable transmission of data frames. According to the standard, any erroneous frame is retransmitted up to a certain limited number of times. The present invention proposes a novel mechanism that enhances the reliability of frame transmission that can be incorporated into the IEEE 802.11 standard at the MAC layer.

### SUMMARY OF THE INVENTION

The present invention relates to a new frame structure for communications over a WLAN.

According to one aspect of the invention, a system for communicating data in a wireless local area network (WLAN) is provided and includes at least one first station capable of transmitting and receiving data modulated according to a first modulation scheme, and at least one second station capable of transmitting and receiving data modulated using the first modulation scheme, wherein the first and second stations retransmit data according to a second modulation scheme when a transmission error occurs more than a predetermined number of times. The first modulation scheme is an OFDM modulation scheme, and the second modulation scheme is an OFDM modulation scheme.

According to another aspect of the invention, a method for reducing the transmission error in a wireless local area network (WLAN) having a first station and a second station is provided. The method includes the steps of detecting whether a transmission error occurs more than a predetermined number of times when one of the first and second stations transmit data using a first modulation scheme; if so, detecting a transmission rate of the data according to the first modulation scheme; determining whether the transmission rate of the data according to the first modulation scheme is greater than a predetermined data rate; and, if so, retransmitting the data using a second modulation scheme.

The invention also relates to an access point and a station in such a system.

### BRIEF DESCRIPTION OF THE DRAWING

The invention is explained in further details, by way of examples, and with reference to the accompanying drawing wherein:

FIG. 1 shows a wireless local area network of the invention;

FIG. 2 is a frame format showing the optional forward-error-correction (FEC) periods in a wireless local area network;

FIG. 3 is a frame format showing the PPDU format of 802.11a PHY;

FIG. 4 is a flow chart showing the operation steps of enhancing the transmission of a frame according to the teachings of the present invention; and,

FIG. 5 is a frame format used to enhance the transmission of a frame according to the teachings of the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

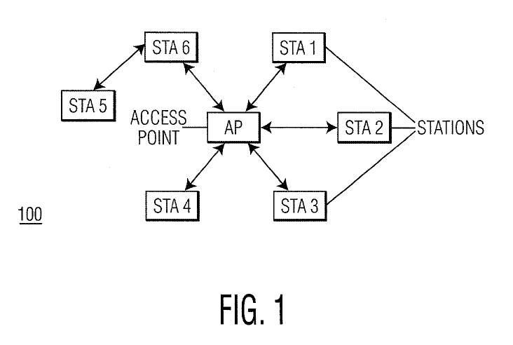

Referring to FIG. 1, an 802.11 wireless local area network 100 of the present invention comprises an access point AP and a plurality of stations STA1-STA6. A station STA may communicate with another station directly as described in the IEEE 802.11e extension or a station STA may communicate with another station STA via the access point AP or the station STA may communicate with the access point AP only. According to the standard, any erroneous frame is retransmitted up to a predetermined number of times. The IEEE 802.11e Medium Access Control (MAC) further defines an optional MAC-level Forward-Error Correction (FEC), based on a well-known Reed-Solomon (RS) code, for a more reliable transmission of data frames.

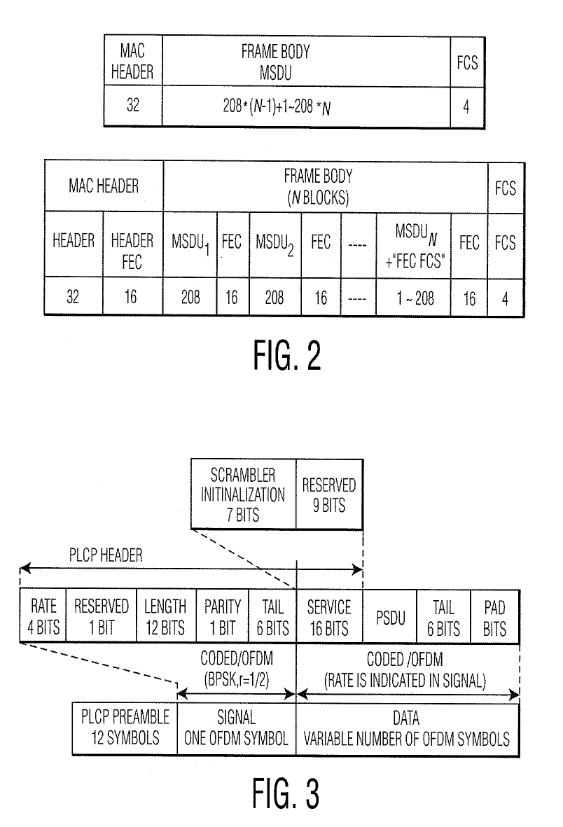

FIG. 2 shows the MAC-Protocol-Data-Unit (MPDU) format defined in the draft specification of IEEE 802.11e with optional FEC, where each number represents the corresponding size in octets. Briefly, a (224, 208) shortened Reed-Solomon (RS) code, defined in GF (256), is used. As a MAC-Service-Data Unit (MSDU), from the higher layer can be much larger than 208 octets, the MADU may be split into (up to 12) multiple blocks, and each block is encoded by the RS encoder separately. The last RS block in the frame body can be shorter than 224 octets by using a shortened code. A (48, 32) RS code, which is also a shortened RS code, is used for the MAC header, and CRC-32 is used for the Frame-Check Sequence (FCS). Note that any RS block can correct up to 8 byte errors. The outer FCS allows the receiver to skip the RS decoding process if the FCS is correct. Accordingly, the inner FCS (or FEC FCS) allows the receiver to identify a false decoding by the RS decoder.

In order to facilitate an understanding of this invention, the PPDU format of the IEEE 802.11a PHY will be described in conjunction with FIG. 3.

Referring to FIG. 3, the PPDU format of the IEEE 802.11a PHY includes a PLCP preamble, a PLCP header, an MPDU, tail bits, and pad bits. Note that PSDU is equivalent to MPDU. The MPDU is appended to a physical-layer-convergence-procedure (PLCP) preamble and a PLCP header to create a PLCP protocol-data unit (PPDU) for transmission. At the receiver, the PLCP preamble and header are processed to aid the demodulation of the MPDU. The PLCP-preamble field, with the duration of 16 usec, is composed of 1—repetitions of short-training sequences (0.8 usec) and repetitions of a long-training sequence (4 usec). The PLCP header, except the SERVICE field, with the duration of 4 usec, constitutes a separate OFDM symbol, which is transmitted with a BPSK modulation and rate ½-convolutional coding. The 6 “zero” tail bits are used to return the convolutional decoder to the “zero state,” and the pad bits are used to make the resulting bit-string length a multiple of the OFDM-symbol length (in bits). Each OFDM-symbol interval is 4 usec. The 16-bit—SERVICE field of the PLCP header and the PLCP-Service-Data Unit (PSDU) along with 6 tail bits and pad bits, represented by DATA, are transmitted at the data rate specified in the RATE field. The SERVICE field can be transmitted up to 54 Mbps, whereas the SIGNAL field is always transmitted at 6 Mbps.

However, if an 802.11e MAC-level FEC is used, the transmission error is uncorrectable when used along with the IEEE 802.11a physical (PHY) layer because a part of the PHY header called the SERVICE field can be less reliable than the RS-coded MAC-frame body, thus degrading the utility of the MAC-level FEC. That is, a single error in these 7 bits of the SERVICE field will result in the erroneous reception of the whole frame. Accordingly, a problem arises when the 802.11e MAC FEC is optionally used because the SERIVCE field may be even less reliable than the following PSDU (or MPDU). In this case, the error performance of the SERVICE field ends up imposing the limit on the error performance of the whole-frame transmission, which in turn makes the 802.11e MAC-level FEC less effective. Thus, the implementation of FEC in the PSDU (or MPDU) is not helpful in terms of a whole-frame transmission.

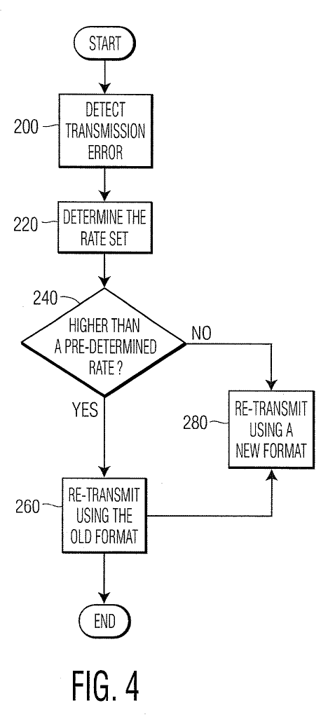

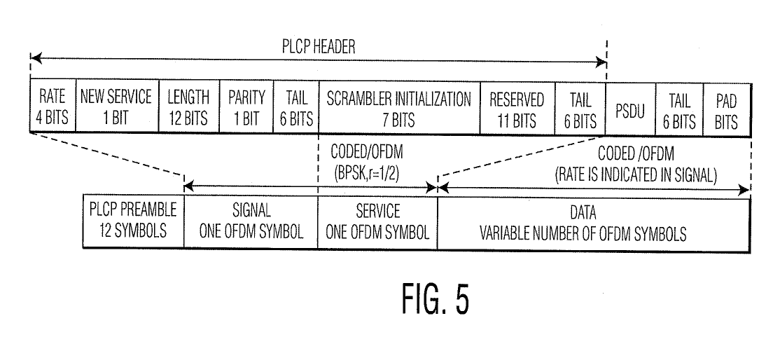

Now, a description that can overcome the above-described problematic situation will be made in detail with reference to FIGS. 4 and 5.

FIG. 4 is a flow chart illustrating the operation steps of reducing error in the frame transmission operable in both 802.11 and 802.11e systems when an 802.11e MAC-level FEC is used.

First, it is determined whether a frame is received in error in step 200 in order to retransmit the frame. If so, the data rate set in the frame is detected at the transmitting station in step 220. Then, it is determined whether the data rate is set higher than 6 Mbps in step 240. If not, the new frame format is not used in step 260; otherwise, the frame is retransmitted using a new PPDU format in step 280, thus reducing the transmission error.

FIG. 5 shows the new PPDU format used in step 280 in accordance with the teachings of the present invention. The PLCP preamble is followed by a PLCP header and DAT field, and the PLCP header consists of the SIGNAL field and the SERVICE field. In the embodiment, a single OFDM symbol using the most reliable scheme, i.e., 6 Mbps, is used for the SERVICE field. By selectively using the new format shown in FIG. 5 based on the detection of transmission error, one can avoid the SERVICE field imposing the limit on the error performance of the whole-frame transmission as the error performance of the new SERVICE field is more reliable, only at the cost of the potential increase of the frame-transmission time by 4 usec, i.e., one OFDM-symbol duration. As a result, the bandwidth is used more efficiently due to less error transmission. Moreover, depending on the length of the PSDU field, the frame-transmission time may not be increased due to the tail bits after PSDU. Alternatively, one can minimize this increased overhead by using this new SERVICE-field format only for the frame encoded with an 802.11e MAC-level FEC and transmitted at a data rate higher than 6 Mbps. Thus, whether the new format/rate of the SERVICE field is used or not can be specified in the New SERVICE bit in the SIGNAL field. Note that this bit is reserved in the current 802.11a PHY, and hence not used. Furthermore, this one-bit indication makes the new frame format backward-compatible with the legacy 802.11a PHY.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

1. A system for communicating data in a wireless local area network (WLAN), comprising:
at least one first station capable of transmitting and receiving data modulated according to a first modulation scheme; and
at least one second station capable of transmitting and receiving data modulated using the first modulation scheme,
wherein the first and second stations retransmit data according to a second modulation scheme when a transmission error occurs more than a predetermined number of times.

2. The system of claim 1, wherein the first modulation scheme is an OFDM modulation scheme.

3. The system of claim 1, wherein the first station is an access point of the wireless local area network (WLAN).

4. The system of claim 1, wherein the second modulation scheme includes an information field representative of the transmission rate that is lower than the first modulation scheme.

5. The system of claim 1, wherein the second modulation scheme is an OFDM modulation scheme.

6. The system of claim 1, wherein the system operates under the IEEE 802.11 specification.

7. The system of claim 1, wherein the second station is an access point of a local area network.

8. An access point for communicating over a local area network with a first station capable of transmitting and receiving data modulated according to a first modulation scheme and a second station capable of transmitting and receiving data modulated using the first modulation scheme, wherein the first and second stations retransmit data according to a second modulation scheme when a transmission error occurs more than a predetermined number of times.

9. A method for reducing the transmission error in a wireless local area network (WLAN) having a first station and a second station, the method comprising:
detecting whether a transmission error occurs more than a predetermined number of times when one of the first and second stations transmit data using a first modulation scheme;
if so, detecting a transmission rate of the data according to the first modulation scheme;
determining whether the transmission rate of the data according to the first modulation scheme is greater than a predetermined data rate; and,
if so, retransmitting the data using a second modulation scheme.

10. The method of claim 9, wherein the first modulation scheme is an OFDM modulation scheme.

11. The method of claim 9, wherein the second modulation scheme includes an information field representative of the transmission rate that is lower than the first modulation scheme.

12. The method of claim 9, wherein the second modulation scheme is an OFDM modulation scheme.

13. The method of claim 9, wherein the first and second stations operate under the IEEE 802.11 specification.

14. A system for communicating data in a wireless local area network (WLAN), comprising:
a first station capable of transmitting and receiving data modulated according to a first modulation scheme;
a second station capable of transmitting and receiving data modulated using the first modulation scheme; and,
an access point for communicating with the first and the second stations,
wherein the first and second stations retransmit data according to a second modulation scheme when a transmission error occurs more than a predetermined number of times.

15. The system of claim 14, wherein the first modulation scheme is an OFDM modulation scheme.

16. The system of claim 14, wherein the second modulation scheme includes an information field representative of the transmission rate that is lower than the first modulation scheme.

17. The system of claim 14, wherein the second modulation scheme is an OFDM modulation scheme.

18. The system of claim 14, wherein the system operates under the IEEE 802.11 specification.
